(19) United States
(12) Patent Application Publication
(10) Pub. No.: US 2016/0147921 A1
(43) Pub. Date: May 26, 2016

(54) MAKING AVAILABLE A MODEL OF THE SURROUNDINGS WHEN A SENSOR OF A VEHICLE FAILS

(71) Applicant: Bayerische Motoren Werke Aktiengesellschaft, Muenchen (DE)

(72) Inventor: Benoit VANHOLME, Muenchen (DE)

(21) Appl. No.: 15/010,589

(22) Filed: Jan. 29, 2016

Related U.S. Application Data
(63) Continuation of application No. PCT/EP2014/065916, filed on Jul. 24, 2014.

(30) Foreign Application Priority Data
Aug. 1, 2013 (DE) 10 2013 215 100.4

(51) Int. Cl. G06F 17/50; B60W 50/029; B60W 40/02

(52) U.S. Cl. CPC G06F 17/5009; B60W 40/02; B60W 50/029

(57) ABSTRACT

A method for providing models of surroundings of a vehicle is provided when a first sensor of a vehicle fails, where the vehicle comprising the first sensor, wherein the models of the surroundings each provide information relating to an occupation of the surroundings by one or more objects up to a predetermined distance limit from the vehicle. The method includes providing a first model of the surroundings based on at least the measurements of the first sensor at a first time at which the first sensor was still functional, and determining that the first sensor is non-functional at a second time. The method includes providing a second model of the surroundings, in response to the determining, by supplementing the first model of the surroundings with information relating to the occupation by a phantom object, wherein the phantom object is an object not detected based on sensor measurements. Finally, the method includes determining the occupation by the phantom object in the second model of the surroundings taking into account the distance limit of the first model of the surroundings.

### CROSS REFERENCE TO RELATED APPLICATIONS

This application is a continuation of PCT International Application No. PCT/EP2014/065916, filed Jul. 24, 2014, which claims priority under 35 U.S.C. §119 from German Patent Application No. 10 2013 215 100.4, filed Aug. 1, 2013, the entire disclosures of which are herein expressly incorporated by reference.

### BACKGROUND AND SUMMARY OF THE INVENTION

The invention relates to a method for providing a model of the surroundings when a first sensor of a vehicle fails, to a corresponding computer program and a computing apparatus and to a vehicle for the same purpose.

In future, motor vehicles will have an abundance of driver assistance systems which warn the driver of collisions, for example, and possibly also attempt to avoid collisions by means of interventions. Examples of such driver assistance systems are an emergency brake assistant, a lane-keeping assistant, a blind spot assistant, a parking assistant and a so-called automatic cruise control (ACC) assistant, in particular for freeway journeys. In addition, highly automated driving, that is to say the movement of a vehicle without (or substantially without) human intervention, also presupposes knowledge of the surroundings of the vehicle. In order to provide these functions, knowledge of the surroundings of the vehicle is decisive for driver assistance systems. For this purpose, the surroundings are scanned or recorded using one or more sensors such as radar, lidar, camera, ultrasonic sensors or similar sensors known from the prior art. The occupation of the surroundings by objects is then detected with the aid of the sensor measurements with the aid of signal processing methods which are likewise known in the prior art. The occupation indicates that the surroundings cannot be traversed by the vehicle in a particular section and therefore indicates the position of the object. The type of objects is additionally detected, that is to say whether the objects are pedestrians, vehicles, road boundaries, etc. The detected occupation and the types of objects are used to create a model of the surroundings which provides information relating to the occupation of the surroundings by objects, that is to say, in particular, those sections of the surroundings which are occupied by objects, and the type of objects.

One concept for highly automated driving on freeways on the basis of a model of the surroundings is presented, for example, in “A legal safety concept for highly automated driving on highways” by Benoit Vanholme, et al., Intelligent Vehicles Symposium (IV), 2011 IEEE, Jun. 5-9, 2011, pages 563-570. Such a concept is likewise presented in the dissertation “Highly Automated Driving on Highways based on Legal Safety”, University of Evry-Val-d'Esssonne dated Jun. 18, 2012 by Benoit Vanholme. This publication also presents the concept of phantom objects. In this publication, a phantom object is a fictitious object which is assumed at a distance for which no occupation can be created with the aid of the sensors of the vehicle because the measurement range of the sensors has been exceeded.

The basis of the model of the surroundings is the scanning of the surroundings with the aid of one or more sensors. In most cases, it is no longer possible to create a valid model of the surroundings as soon as one sensor fails. A type of emergency procedure is typically provided by the driver assistance systems for this situation during highly automated driving, which procedure substantially involves driving the vehicle as quickly as possible to the roadside and braking it. This may result in intense and uncomfortable maneuvers of the vehicle and may even increase the risk of an accident under certain circumstances.

An object of the invention is to enable an improved possible reaction for driver assistance systems based on models of the surroundings if a sensor fails.

A first aspect relates to a method for providing a model of the surroundings when a first sensor of a vehicle fails, the vehicle comprising the first sensor, on the basis of at least the measurements of which models of the surroundings are created for the vehicle in succession, the models of the surroundings each providing information relating to the occupation of the surroundings by objects, the information being provided only for occupation up to a predetermined distance limit starting from the vehicle, the method comprising: providing a first model of the surroundings which was created on the basis of at least the measurements of the first sensor at a first time at which the first sensor was still functional; determining that the first sensor is non-functional at a second time; in response to the determination: providing a second model of the surroundings by supplementing the first model of the surroundings with information relating to the occupation by a phantom object, namely an object not determined on the basis of sensor measurements, the providing process comprising: determining the occupation by the phantom object in the second model of the surroundings taking into account the distance limit of the first model of the surroundings. The first time is, in particular, the time at which the sensor was last functional and provided measurements before it became non-functional.

It is therefore proposed to provide a phantom object in the second model of the surroundings outside the section which can be used to determine occupation with the aid of the sensor if a sensor fails. The phantom object represents a safety assumption since, on account of the non-functional sensor, no statement can be made on the actual occupation of the space on the far side of the distance limit. The second (extended) model of the surroundings then serves the driver assistance systems as a basis for performing their function, in particular stopping of the vehicle, precisely on the basis of the second model of the surroundings, even when the first sensor fails. In comparison with rigid emergency rules for the failure of a sensor (see above), this has the advantage that already existing knowledge of the surroundings, that is to say the first model of the surroundings, continues to be used and only a phantom object is inserted taking into account the distance limit of the first model of the surroundings. On the one hand, this knowledge can prevent possible accidents by virtue of occupation which has already been detected continuing to be avoided and, on the other hand, comfort can be increased in many cases since the space to the distance limit of the first model of the surroundings often enables a more gentle maneuver than would be possible when applying the emergency rule. The emergency rule often provides for the vehicle to be stopped in a shorter distance than the distance limit of the first model of the surroundings is away.

In one case, the phantom object is a stationary object, the occupation of the phantom object being determined in the second model of the surroundings outside and/or at the distance limit of the first model of the surroundings. The phantom object is therefore assumed to be stationary, in which case a low speed, for example less than 3 km/h, can also be considered to be stationary. The phantom object therefore represents the limit up to which the surroundings have been detected. In a conservative assumption, this is the region which can be used for driving maneuvers and emergency stop maneuvers, occupation detected in this region naturally having to be taken into account. This assumption is useful, for example, during a journey on the freeway or a one-way street, where no oncoming phantom objects are assumed.

In another case, a movement is assigned to the phantom object, it being assumed, when determining the occupation by the phantom object, that the occupation by the phantom object at the first time was outside and/or at the distance limit of the first model of the surroundings, and the occupation by the phantom object being determined in the second model of the surroundings taking into account the assumption of the movement of the phantom object, the occupation at the first time and the time difference between the first and second times. In this case, a moving object is therefore assumed for the phantom object. The possible future travel trajectory or a plurality of possible driving trajectories can be assumed as the movement. If appropriate, an assigned occurrence probability can be assumed for each travel trajectory. From the position at or outside the distance limit, the assumed occupation is then updated from the first time to the second time according to the movement and is added to the second model of the surroundings. If the vehicle is on a two-lane country road, for example, an oncoming vehicle in the oncoming lane, which is currently outside the distance limit in front of the vehicle in the direction of travel in the oncoming lane at the first time, can be assumed to be a phantom object if a sensor fails.

The movement assigned to the phantom object can be determined with the aid of a pre-stored assignment. This links the (additionally detected) type of surroundings (freeway, two-lane country road, city traffic) to the movement to be assigned to the phantom object, for example.

A plurality of phantom objects can be added to the first model of the surroundings when providing the second model of the surroundings. At least one of the phantom objects can be a stationary object and a movement can be assigned to at least one of the phantom objects.

The non-functionality of a sensor may show in a complete failure, that is to say in the fact that the sensor no longer reacts. In addition, the non-functionality of a sensor may also show in the fact that the measured values provided by the sensor appear to be incorrect. Other malfunctions of the sensor can likewise be deemed to be non-functionality.

The occupation can be determined using the distance limit of the model of the surroundings, with the result that the occupation is positioned precisely on the far side of the limit for which sensor measurements are still available, in other words: precisely within the region or at the boundary of the region (for example 1 m or 0.5 m away from the boundary of the region). The occupation by the phantom object can be specified by means of a pre-stored assignment.

In one development, the model of the surroundings is created on the basis of the measurements of a group of sensors of the vehicle, the second model of the surroundings being provided only if the first sensor and a further sensor in the group of sensors are non-functional. If appropriate, it is possible to determine the occupation of the surroundings despite the failure of the first sensor. In this case, the creation of the occupation must be impaired in order to initiate the generation of the second model of the surroundings.

In one implementation, the distance limit is the perception limit of the first sensor. Occupation is therefore determined for the model of the surroundings up to the distance up to which meaningful sensor measurements are available.

In one preferred development, the occupation of the phantom object surrounds and/or overlaps the distance limit in front of (or to the side of or behind) the vehicle in the direction of travel. Therefore, the phantom object does not have the typical form of another road user such as a vehicle or pedestrian. Instead, the phantom object follows the form of the distance limit. If, for example, the distance limit forms a rectangle with the vehicle at the center of the rectangle, the phantom object has the form of a U. The thickness of the phantom object can be freely selected in this case, for example 0.5 m, 1 m or 5 m. The phantom object can also lie on the distance limit, that is to say overlap the latter.

In another typical implementation, the occupation by the phantom object in the form of another road user may likewise be assumed, for example an overtaking vehicle approaching from behind (in particular an automobile on a freeway).

The occupation of the phantom object may also completely surrounds and/or overlaps the distance limit. In the case of a rectangular form of the distance limit, the phantom object therefore likewise has this form.

In another aspect, a computer program causes a computer to carry out one of the methods above during the execution of the computer program.

In another aspect, a computing apparatus comprises electronic computing means which are set up to carry out one of the methods above. The electronic computing means may be a computer, a microcontroller or dedicated circuits. The computing apparatus may be caused to carry out the method by a computer program.

In yet another aspect, a motor vehicle comprises sensors for detecting objects in the surroundings of the vehicle and an above computing apparatus.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an exemplary model of the surroundings according to one exemplary embodiment in the case of functional sensors.

FIG. 2 shows an exemplary supplemented model of the surroundings according to one exemplary embodiment if a sensor fails.

Identical reference symbols relate to corresponding elements throughout the figures.

### DETAILED DESCRIPTION OF THE DRAWINGS

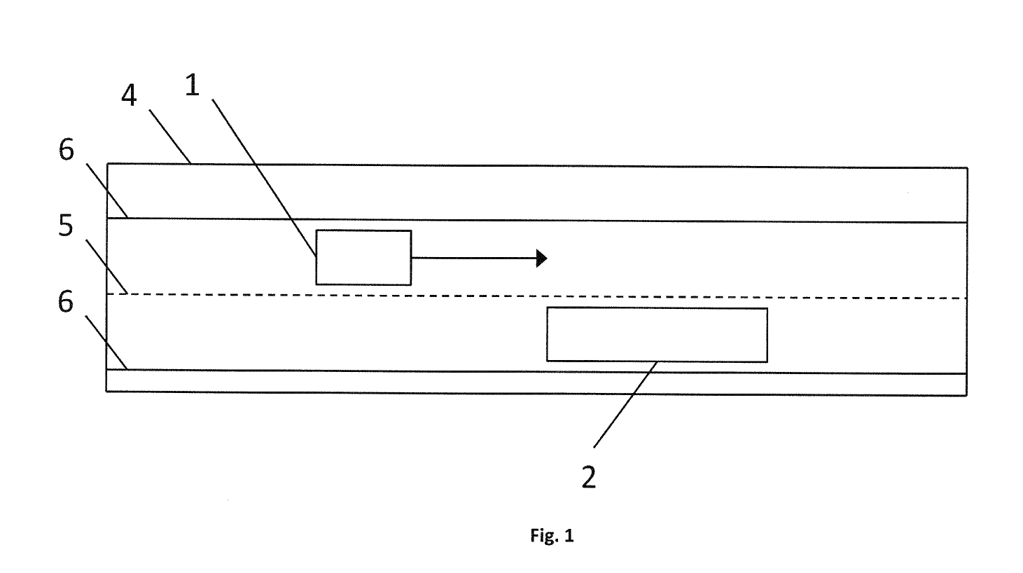

FIG. 1 shows an exemplary model of the surroundings according to one exemplary embodiment in the case of functional sensors. A vehicle 1 is on a road, which is indicated by the road boundary 6 and the median strip 5, and is traveling in a highly automated manner under the control of corresponding driver assistance systems in accordance with the illustrated arrow which indicates the future travel trajectory. The vehicle 1 has a sensor for detecting the surroundings and creates a model of the surroundings with the aid of the sensor measurements of the sensor functional at a first time. The model of the surroundings indicates the occupation of the surroundings by objects and their type. The model of the surroundings depicts occupation inside the distance limit 4 which is defined by the range of the sensors and computing capacities. In the surroundings, the vehicle 1 detects the road boundaries 6, the median strip 5 and the stationary bus 2 in the right-hand lane.

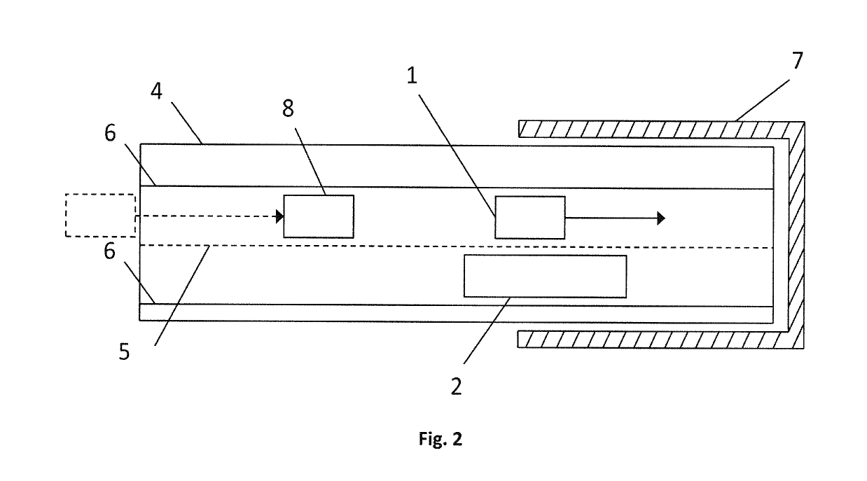

At a second time, the vehicle detects that the sensor has become non-functional and that occupation of the surroundings of the vehicle can no longer be detected with the aid of the sensor measurements. The vehicle then creates an extended (second) model of the surroundings which is generated on the basis of the first model of the surroundings. The second model of the surroundings is shown in FIG. 2. In order to create the second model of the surroundings, the information relating to occupation of the surroundings by a phantom object 7 is added to the first model of the surroundings. This phantom object surrounds the distance limit 4 which is in front of the vehicle 1 in the direction of travel of the vehicle 1 (the start of the phantom object is in the center of the vehicle 1). In this example, the phantom object maintains a distance of 0.5 m from the distance limit 4 at any point and has a thickness of 0.5 m in this example. The phantom object 8 which represents a vehicle which is traveling more quickly in the left-hand lane is also added. For this phantom object, it is assumed that it was precisely outside the distance limit 4 at the first time (dashed version of the object 8). For the vehicle 8, a future movement in the form of a travel trajectory (including a speed) was assumed (dashed arrow) at the first time. The second model of the surroundings takes into account the distance limit 4 which applies to the first model of the surroundings. In the second model of the surroundings, the vehicle 1 is placed differently in accordance with its movement. The phantom object 8 is also likewise offset according to its assumed travel trajectory. The assumed future travel trajectory of the phantom object 8 is represented by a solid arrow. On the basis of this second model of the surroundings according to FIG. 2, the driver assistance systems can then initiate an emergency stop in a highly automated manner. If firmly defined rules were used for an emergency stop, the driver assistance systems would immediately brake the vehicle and would allow it to change to the right-hand lane or the hard shoulder. This could result in an accident involving the bus 2. In contrast, the use of the second model of the surroundings makes it possible for the driver assistance systems to take the bus 2 into account when carrying out the emergency stop. At the same time, the consideration of the phantom object 8 makes it possible to take into account traffic behind the vehicle. There would be a risk of an accident involving the phantom object 8 if the vehicle 1 were to abruptly brake in its lane. Overall, a driver assistance system could therefore arrive at a planned travel trajectory, as illustrated with the solid arrow for the vehicle 1. It is therefore possible to avoid an accident involving the bus 2 and a possibly trailing vehicle (represented by the phantom object 8).

In one development, the movement of the objects detected in the surroundings (that is to say a moving bus 2, for example) is detected at the first time, and the detected objects are newly placed in the second model of the surroundings in accordance with the progression of time between the first and second times and according to the movement assumed from the first time onward. The assumed movement may be the updating of the detected movement in a simple case.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for providing models of surroundings of a vehicle when a first sensor of a vehicle fails, the vehicle comprising the first sensor, wherein the models of the surroundings each provide information relating to an occupation of the surroundings by one or more objects up to a predetermined distance limit from the vehicle, the method comprising:
providing a first model of the surroundings based on at least the measurements of the first sensor at a first time at which the first sensor was still functional;
determining that the first sensor is non-functional at a second time;
providing a second model of the surroundings, in response to said determining, by supplementing the first model of the surroundings with information relating to the occupation by a phantom object, wherein the phantom object is an object not detected based on sensor measurements; and
determining the occupation by the phantom object in the second model of the surroundings taking into account the distance limit of the first model of the surroundings.

2. The method as claimed in claim 1, wherein the phantom object is a stationary object and the occupation of the phantom object is determined in the second model of the surroundings outside and/or at the distance limit of the first model of the surroundings.

3. The method as claimed in claim 1, further comprising assigning a movement to the phantom object,
wherein, when determining the occupation by the phantom object, an assumption is made that the occupation by the phantom object at the first time is outside and/or at the distance limit of the first model of the surroundings, and
wherein said determining the occupation by the phantom object in the second model comprises determining the occupation by the phantom object in the second model by taking into account each of the assumption of the movement of the phantom object, the occupation at the first time, and a time difference between the first time and second time.

4. The method as claimed in claim 1, wherein the first model and second model of the surroundings are based on measurements of a group of sensors of the vehicle, wherein the second model of the surroundings is provided only if the first sensor and a further sensor in the group of sensors are non-functional.

5. The method as claimed in claim 2, wherein the first model and second model of the surroundings are based on measurements of a group of sensors of the vehicle, wherein the second model of the surroundings is provided only if the first sensor and a further sensor in the group of sensors are non-functional.

6. The method as claimed in claim 3, wherein the first model and second model of the surroundings are based on measurements of a group of sensors of the vehicle, wherein the second model of the surroundings is provided only if the first sensor and a further sensor in the group of sensors are non-functional.

7. The method as claimed in claim 1, wherein the distance limit is a perception limit of the first sensor.

8. The method as claimed in claim 1, wherein the occupation of the phantom object surrounds and/or overlaps the distance limit in front of the vehicle in a direction of travel.

9. The method as claimed in claim 2, wherein the occupation of the phantom object surrounds and/or overlaps the distance limit in front of the vehicle in a direction of travel.

10. The method as claimed in claim 3, wherein the occupation of the phantom object surrounds and/or overlaps the distance limit in front of the vehicle in a direction of travel.

11. The method as claimed in claim 4, wherein the occupation of the phantom object surrounds and/or overlaps the distance limit in front of the vehicle in a direction of travel.

12. The method as claimed in claim 1, wherein the occupation of the phantom object completely surrounds and/or overlaps the distance limit.

13. The method as claimed in claim 2, wherein the occupation of the phantom object completely surrounds and/or overlaps the distance limit.

14. The method as claimed in claim 3, wherein the occupation of the phantom object completely surrounds and/or overlaps the distance limit.

15. The method as claimed in claim 4, wherein the occupation of the phantom object completely surrounds and/or overlaps the distance limit.

16. A computing apparatus comprising electronic computing means configured to provide models of surroundings of a vehicle when a first sensor of a vehicle fails, the vehicle comprising the first sensor, wherein the models of the surroundings each provide information relating to an occupation of the surroundings by one or more objects up to a predetermined distance limit from the vehicle, the electronic computing means being configured to:
provide a first model of the surroundings based on at least the measurements of the first sensor at a first time at which the first sensor was still functional;
determine that the first sensor is non-functional at a second time;
provide a second model of the surroundings, in response to said determining, by supplementing the first model of the surroundings with information relating to the occupation by a phantom object, wherein the phantom object is an object not detected based on sensor measurements; and
determine the occupation by the phantom object in the second model of the surroundings taking into account the distance limit of the first model of the surroundings.

17. A motor vehicle comprising:
sensors for detecting objects in the surroundings of the vehicle, including a first sensor; and
the computing apparatus as claimed in claim 16.
